(19) United States
(12) Patent Application Publication
(10) Pub. No.: US 2014/0369800 A1
(43) Pub. Date: Dec. 18, 2014

(54) PALLETISER

(71) Applicant: Foodmach Pty Ltd., Echuca (AU)

(72) Inventors: Peter Geoffrey Marks, Moama (AU); Seyed Ali Mirfendereski, Glen Waverley (AU); Justin Illingworth Hindle, Blackburn North (AU); Scott Alan Anderson, Echuca (AU); Kenneth James Orr, Echuca (AU); Dallas Andrew Coote, Echuca (AU)

(21) Appl. No.: 14/367,003

(22) PCT Filed: Dec. 21, 2012
(86) PCT No.: PCT/AU2012/001580

§ 371 Date: Jun. 19, 2014

(30) Foreign Application Priority Data
Dec. 21, 2011 (AU) 2011905366

(51) Int. Cl. B65G 47/91; B65G 61/00; B65G 57/03; B65G 47/74; B65G 47/82

(52) U.S. Cl. CPC B65G 47/91; B65G 47/74; B65G 47/82; B65G 57/03; B65G 61/00
USPC 414/792.8; 414/802

(57) ABSTRACT

A palletiser (10) including a conveyor (11) for conveying objects (14-18) to be palletised to a loading region (27) and a palletising head (26) which is movable between the loading region (27) and a palletising region (28). The palletising head (26) is rotatable and has first and second movable abutments (35, 36) which are oriented generally perpendicular to each other. Each movable abutment (35, 36) is movable relative to and independently of the other movable abutment (35, 36) in a manner to maintain the generally perpendicular orientation between them. The movable abutments (35, 36) are operable to engage surfaces of one or more objects (14-18) to be palletised in the loading region (27), the surfaces being generally perpendicular to each other. Upon that surface engagement, the palletising head (26) is operable to shift the objects (14-18) from the loading region (27) to the palletising region (28) and to orientate the objects (14-18) through rotation of the palletising head (26) to adopt a selected pattern of objects in the palletising region (28).

### FIELD OF THE INVENTION

The present invention relates palletising systems and equipment, for palletising objects for transport and/or storage. It will be convenient to describe the invention as is relates to the palletising of cartons, such as cardboard cartons which are generally square or rectangular in shape, within which objects are packaged, although it is to be appreciated that the invention is not limited just to the palletising of cartons. For example, the present invention can be employed for palletising shrink wrapped drink containers.

### BACKGROUND OF THE INVENTION

A reference herein to prior art is not to be taken as an admission that that prior art was known or that it was part of the common general knowledge as at the priority date of any of the claims.

Palletising systems and equipment are used for placing objects on pallets for transport and storage. The objects are often cardboard cartons of square or rectangular configuration within which are packaged a plurality of items, such as food items or drink containers.

The objects to be palletised are normally fed to a palletising station by a conveyor and once at the station, the objects are shifted to position them on a pallet. It is normally necessary to manipulate the orientation of the objects so that they are correctly positioned on the pallet. In this respect, palletising objects normally requires them to be positioned in a particular pattern on the pallet, to maximise the number of objects that can be placed on a pallet. The size and shape of the objects influences the pattern that is selected. Other influencing factors include the weight of the objects and their stacking strength, and the level of carton stability, particularly for tall cartons that have a small footprint.

Palletising systems are available in different forms. In some forms, the systems employ a pick and place arrangement and some forms of such an arrangement employ suction to lift a single object from a loading station for placement on a pallet, or onto an intermediate surface for later placement on a pallet. The object is oriented to the correct position as it travels from the loading station. In this form of palletiser, the position the object has at the loading station is not important, as system can assess the orientation of the object as it is lifted from the loading station and reposition the object as required to form the pallet pattern that has been selected. However, this system is limited in the speed of loading because of the need to lift and place each object individually.

Other forms of pick and place arrangements can palletise more than one object at a time by incorporating an infeed collation system that pre-forms arrays or groups of objects to be picked up by a vacuum (or other) gripper and placed on the pallet. This increases the speed of palletising over the above single object placement arrangement discussed above, because more than a single object can be processed at a time. Infeed collation systems generally are designed for a particular pattern or format of objects on a pallet and as such, these systems are generally inflexible for changing patterns or adding new patterns. Thus, the benefit of increased speed comes with a consequential disadvantage of limited flexibility.

Other pick and place palletising systems utilise grippers to grip objects and otherwise operate in a similar manner to the suction system discussed above. These systems however suffer from the same disadvantages as the suction system in relation to the speed of palletising given that each object must be individually lifted and placed.

The applicant has recognised that a palletiser which can operate at faster palletising speeds than prior art systems would be desirable. The applicant has also recognised that a palletiser which can operate at faster palletising speeds than prior art systems and which can provide flexibility in relation to changing palletising patterns or adding new palletising patterns would be desirable.

### SUMMARY OF THE INVENTION

According to the present invention there is provided a palletiser including a conveyor for conveying objects to be palletised to a loading region, a palletising head which is movable between the loading region and a palletising region, the palletising head being rotatable about a generally vertical axis and having first and second movable abutments which are oriented generally perpendicular to each other, each movable abutment being movable relative to and independently of the other movable abutment in a manner to maintain the generally perpendicular orientation between them, the movable abutments being operable to engage surfaces of one or more objects to be palletised in the loading region, the surfaces being generally perpendicular to each other and upon that surface engagement, the palletising head being operable to shift the objects from the loading region to the palletising region and to orientate the objects through rotation of the palletising head to adopt a selected pattern of objects in the palletising region.

The present invention also provides a palletising head for engaging objects to be palletised, the palletising head having first and second movable abutments which are oriented generally perpendicular to each other, each movable abutment being movable relative to and independently of the other movable abutment in a manner to maintain the generally perpendicular orientation between them, the movable abutments being operable to engage surfaces of one or more objects to be palletised, the surfaces being generally perpendicular to each other and to orientate the objects through rotation of the palletising head to adopt a selected pattern of objects in a palletising region.

The present invention also provides a kit for assembling a palletising head of the above kind.

The present invention further provides a method of palletising objects, the method including conveying objects to be palletised to a loading region, engaging the objects by a palletising head, the palletising head being rotatable and having first and second movable abutments which are oriented generally perpendicular to each other, each movable abutment being movable relative to and independently of the other movable abutment in a manner to maintain the generally perpendicular orientation between them, engaging surfaces of one or more objects to be palletised by the first and second movable abutments in the loading region, the surfaces being generally perpendicular to each other and upon that surface engagement, shifting the objects by the palletising head from the loading region to a palletising region and during that shift, orientating the objects through rotation of the palletising head to adopt a selected pattern of objects in the palletising region.

The invention advantageously allows for high speed manipulation of objects for palletising, by enabling more than a single object to be shifted between the loading region and the palletising region at one time. Thus, the invention is not limited to an arrangement in which only a single object can be shifted between the loading and palletising regions at one time. In contrast, the invention contemplates shifting two, three or more objects at one time. This can comprise two, three or more square or rectangular cartons for example at one time. Thus, the speed in which the objects can be palletised can be increased dramatically compared to arrangements which are limited to the movement of single objects at a time.

Quite conveniently however, where it is necessary to palletise single objects at one time, the invention can accommodate this. What the invention provides is flexibility in an arrangement which allows the operator to select or programme the number of objects to be palletised at one time. This differs from the palletising arrangements discussed above that employ infeed collation systems, because the present invention can provide complete flexibility for changing the pattern or format of objects which are loaded onto a pallet.

Moreover, the invention can be arranged so that, depending on the pattern of objects to be palletised, different numbers of objects can be engaged and shifted at different times. For example, in some palletised patterns, objects will be shifted in groups of two or three depending on the part of the pattern the palletising process is up to. Thus, for example, one shift of objects from the loading region to the palletising region can shift one object, while the next shift the objects from the loading region to the palletising region can shift four objects.

In a palletiser according to the invention, the palletising head would normally be fixed to one end of a robotic arm and the robotic arm would be operable to move the palletising head between the loading region and the palletising region. The connection between the palletising head and the robotic arm can be a rotatable connection to facilitate rotation of the palletising head.

Alternatively, the palletising head could be fixed to an overhead structure that allows movement of the head between the loading region and the palletising region and that further allows rotation of the palletising head.

While the moveable abutments can take any suitable form, in some forms of the invention, they each present a generally planar engagement surface to engage the objects to be palletised. That engagement surface can be a flat surface, or it can be formed otherwise, such as by a plurality of vertically spaced apart, substantially horizontal bars, whereby the horizontal bars of one of the moveable abutments is intermeshed with the horizontal bars of the other of the moveable abutments. In this arrangement, the positions of the horizontal bars of the respective moveable abutments are such that vertically adjacent bars do not interfere with each other during movement of the moveable abutments. Thus, the horizontal bars of the respective moveable abutments are offset vertically from each other.

In some forms of the invention, objects to be palletised can be engaged by either side of a moveable abutment. That is, each of the opposite sides of movable abutment, the front and rear sides, can form a surface for engaging objects to be palletised. This increases the flexibility with which a palletiser of the invention operates and minimises the amount of rotation required of the palletising head.

Each of the moveable abutments preferably is moveable forward and back, with movement of a first of the moveable abutments being along a first line or in a first direction and movement of a second of the moveable abutments being moveable along a second line or in a second direction, whereby the first and second lines or directions are generally perpendicular to each other. As indicated above, the moveable abutments can be intermeshed, but in that state, they remain moveable relative to the other without interference.

In some forms of the invention, the moveable abutments are each in engagement with a drive plate, whereby movement of the drive plate causes movement of one or both of the abutments. Movement of the drive plate can be arranged in any suitable manner, and in some forms of the invention, the drive plate is engaged by a pair of ball screw drives, a pair of hydraulic or pneumatic rams, or other suitable drive and the drive plate is driveable forward and back by the respective ball screw drives, rams or other suitable drive.

In the above form of the invention, the moveable abutments are in engagement with the drive plate and in some forms of the invention, the respective moveable abutments are in engagement with opposite sides of the plate. The engagement can be made in any suitable manner, but in some forms of the invention, the drive plate has channels formed of each of the opposite sides and the abutments have rails formed for receipt within the channels and the rails can slide within the channels. Thus, the abutments are movable relative to the drive plate and with the drive plate as the drive plate is driven.

The movable abutments can be adjustable for height adjustment so that the objects to be palletised are properly engaged. For example, where the objects to be palletised are tall, the preference is to engage the objects below their centre of gravity, so that the engagement does not tend to push the objects over or topple them. Where the objects are short, the engagement position is not normally so important, particularly where the footprint of the objects is much larger than the height by ratio. Thus, height adjustment can be useful to cater for different shapes and sizes of cartons.

In some forms of the invention, a guide arrangement is provided and which is engaged by the moveable abutments to restrict movement of the abutments to movement which maintains the orientation of the abutments generally perpendicular to each other. The guide arrangement can include first and second generally parallel and spaced apart members or first and second pairs of generally parallel and spaced apart members that are disposed generally perpendicular to each other and each of the members or pairs of members being engaged by a respective moveable abutment. The first and second members or can form a general right angle, while the pairs of members can form a generally square or rectangular frame or can be edges of a generally square or rectangular plate.

In order for the moveable abutments to be guided by the guide arrangement, the abutments can each include a channel or a pair of spaced apart channels to accept a member of the respective first and second members or pairs of members and in this arrangement, the channels slide relative to the respective members upon movement of an abutment as the palletising head moves between the loading region and the palletising region. The channels can be provided at opposite ends of each abutment and at upper regions of each abutment, spaced from the region of the abutment which engages objects to be palletised. Other arrangements can incorporate rollers in place of channels or the guide arrangement can include channels and the abutments can include rails for receipt within the channels. Other arrangements could be employed.

While not required in all forms of the invention, the palletising head can include an arrangement to develop suction in order to apply a suction load to objects to be palletised. A suction load can be applied simply to improve the capture of objects by the palletising head.

Alternatively, the palletising head can include friction material for engagement with objects to be palletised for the same reason. For example, the movable abutments could include a friction material, or where the guide arrangement is formed of a generally square or rectangular plate, the friction material could be applied to the plate, to a face of the plate that comes into contact with the objects to be palletised. The friction material could be a material that resists movement of the objects to be palletised relative to the surface to which the friction material is applied and such materials include rubber or foam material. The friction material could be removable so that different material could be used depending on the type of object surface the material is to frictionally engage.

Effectively, the suction load or the friction material can prevent the objects to be palletised from coming away from the movable abutments as the movable abutments move the object from the loading region to the palletising region. This can be advantageous where the momentum imparted to the objects during that movement tends to cause the objects to shift away from the abutments before the objects have been correctly positioned in the palletising region. It must be understood that the movable abutments are expected to move very quickly in many operations and as they slow as they approach the palletising region, the objects in engagement with the abutments can come away from the abutments unless they are restrained from doing so. A frictional material in engagement with the objects has been found to successfully restrain most objects expected to be palletisable by the present invention and frictional material has a cost advantage over suction.

Frictional material can be applied to the abutment members in any suitable manner and can be applied to the plate of the guide arrangement such as in strips, pads or patches.

A further alternative to suction or friction material is to employ one or more retention plates on the opposite side of the palletising head to the movable abutments. The retention plates can have only a short vertical extension of about 50 mm to engage top faces of a carton or group of cartons, so that the carton or group of cartons is engaged on two faces by the movable abutments and on one or two opposite faces by the retention plates.

### BRIEF DESCRIPTION OF THE DRAWINGS

In order that the invention may be more fully understood, some embodiments will now be described with reference to the figures in which:

FIGS. 1 to 3 are perspective views of a palletising system according to the invention.

FIGS. 4 to 7 are perspective views of a palletising head according to the invention.

FIG. 8 is a perspective view of a portion of the palletising head of FIGS. 4 to 7.

FIG. 9 is an exploded view of the palletising head of FIGS. 4 to 7.

FIGS. 10a to 10m show a sequence of palletising using the palletising head of FIGS. 4 to 7.

### DETAILED DESCRIPTION OF THE DRAWINGS

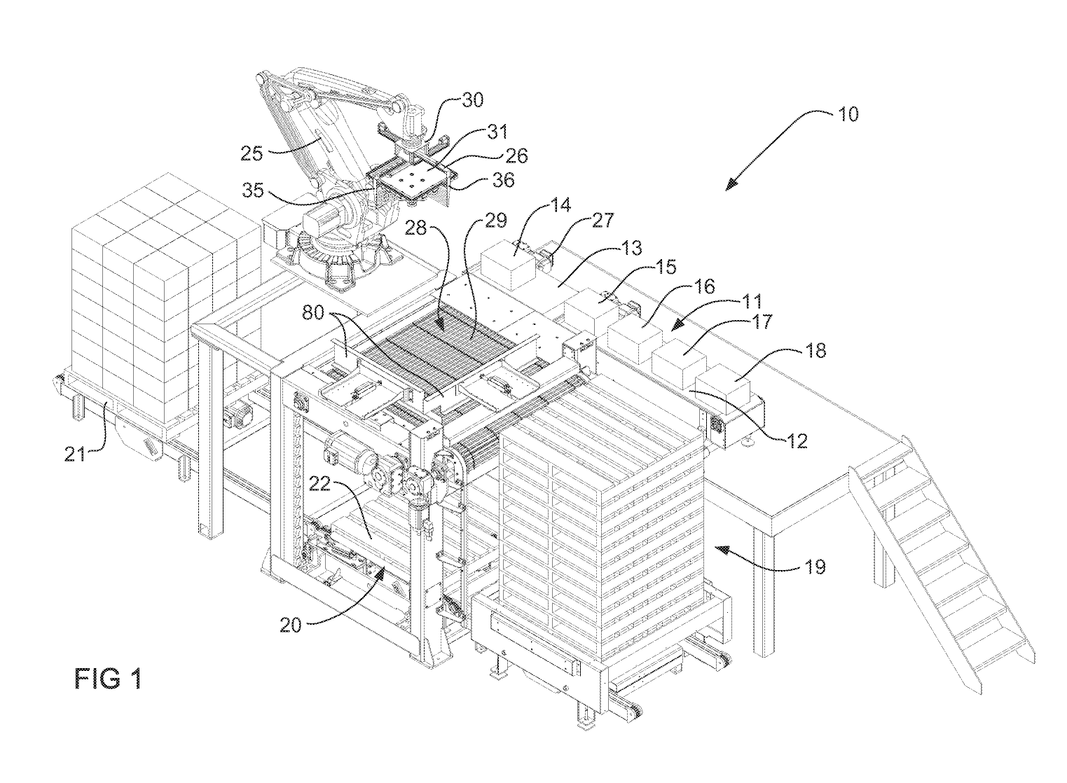

FIG. 1 illustrates in perspective view, a palletising system 10 which includes a conveyor 11 (only a portion of which is shown), that has a pair of belt conveyors 12 and 13. A plurality of cartons 14 to 18 are illustrated on the conveyor 11 with the direction of progress along the conveyor 11 being towards the conveyor 13. The conveyor 12 receives cartons from another section of conveyor that is not illustrated in the figures.

The palletising system 10 includes a plurality of pallets 19 which are loaded into the stacked position shown by forklift and which are fed into the stacking section 20 of the system 10 by an automated arrangement, and as each pallet 19 is loaded to capacity, it is a conveyed out of the system 10 to a dispatch position in which the pallet 21 is located. The pallet 21 is shown loaded with 7 layers of cartons, each layer including 12 cartons. The pallet 21 can be shifted further out of the system 10 as required, or at the position shown, it can be lifted by a forklift or the like and taken to a position either for transport or storage. The next pallet 22 is in position for a new loading of cartons to be placed onto it.

The manner in which the pallets 19 are stacked and conveyed into the stacking section 20 and thereafter moved to the position of the pallet 21 is important for the operation of the palletising system 10 overall, but does not have significant influence on the invention described herein. Accordingly, there will be no further discussion in relation to the mechanisms provided for movement of pallets through the palletising system 10 as it is expected that a person skilled in the art would understand how those mechanisms operate.

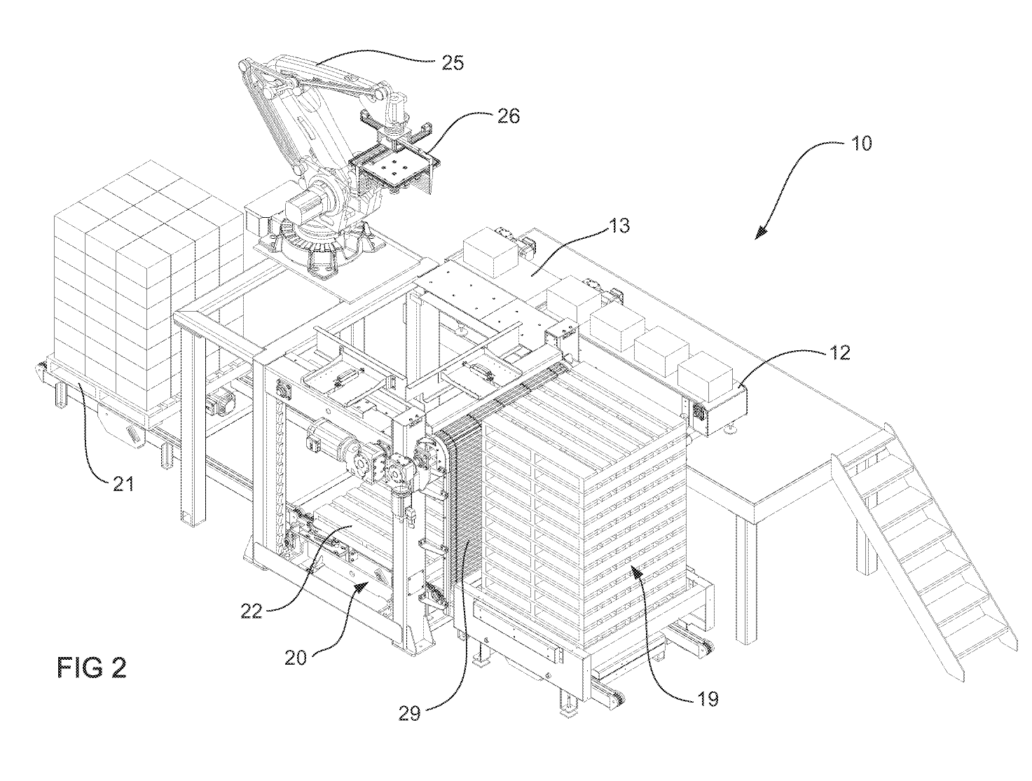

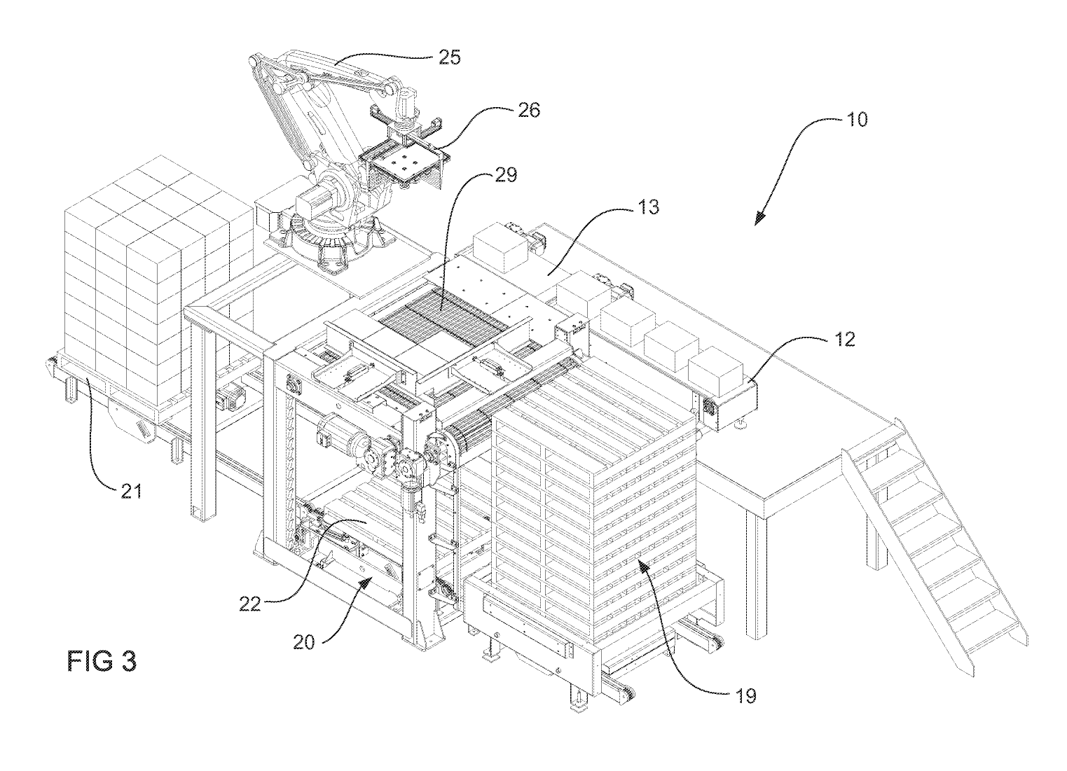

The palletising system 10 includes a robotic arm 25 and a head 26. The robotic arm 25 is rotatable and is articulated, so that it can shift the head 26 from the loading region 27 of the system 10 to the palletising region 28 of the system 10. The loading region 27 is formed at the conveyor section 13 of the conveyor 11, while the palletising region 28 is formed on what is known as a “stripper” 29, which is a supporting surface that is extended to support a layer of cartons placed thereon by the robotic arm 25, and which can be withdrawn to allow the assembled layer to be loaded either directly on to the upper surface of the pallet 22, or on top of a layer which has already been loaded on to the pallet 22. In FIG. 1, the stripper 29 is in the extended position, while in FIG. 2, the stripper has been withdrawn. FIG. 3 shows the stripper with 4 cartons loaded thereon.

The operation of the system 10 in loading the pallet 22 is such that the stripper 29 is extended to the position shown in FIG. 1, and cartons are loaded onto the upper surface of the stripper 29 as shown in FIG. 3. When a full layer of cartons has been loaded on to the stripper 29, the pallet 22 is raised and the stripper 29 withdrawn so that the cartons are transferred from the stripper to the pallet. Thereafter, the stripper is extended to the position shown in FIG. 1 again, further cartons are loaded onto the stripper and the process is repeated as the layers on the pallet 22 are increased. When a sufficient number of layers have been loaded onto the pallet 22, such as shown in relation to the pallet 21, the pallet 22 can be conveyed to the position of the pallet 21 and taken away for further processing.

The robotic arm 25 can rotate about a vertical axis, and the articulated sections of the arm 25 allow the arm 25 to raise and lower the head 26. Thus, the head 26 can be shifted through three-dimensional movement between the loading region 27 and the palletising region 28.

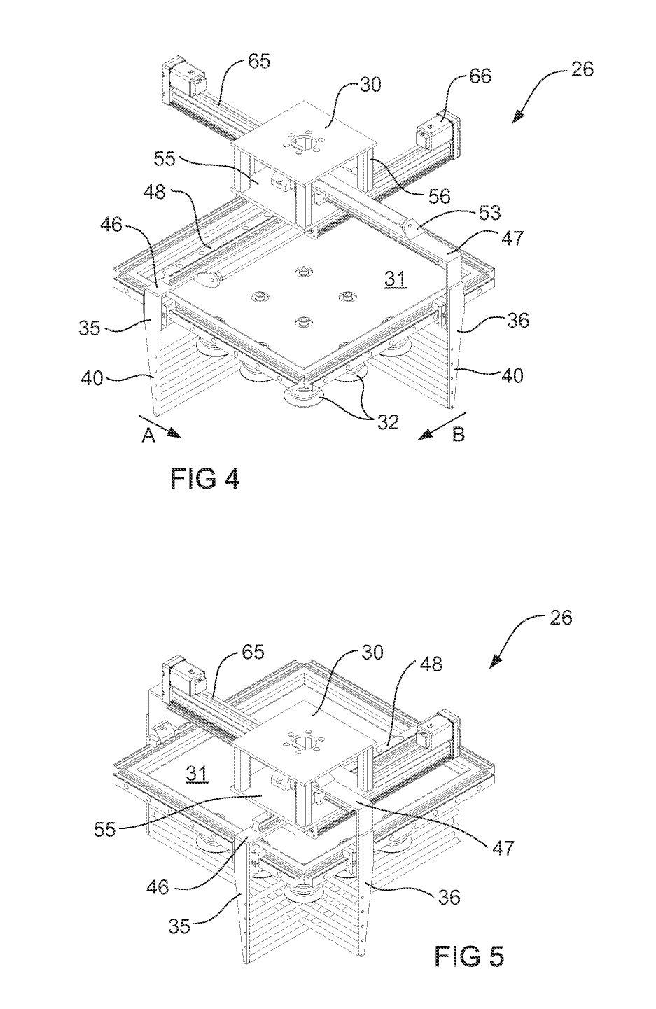

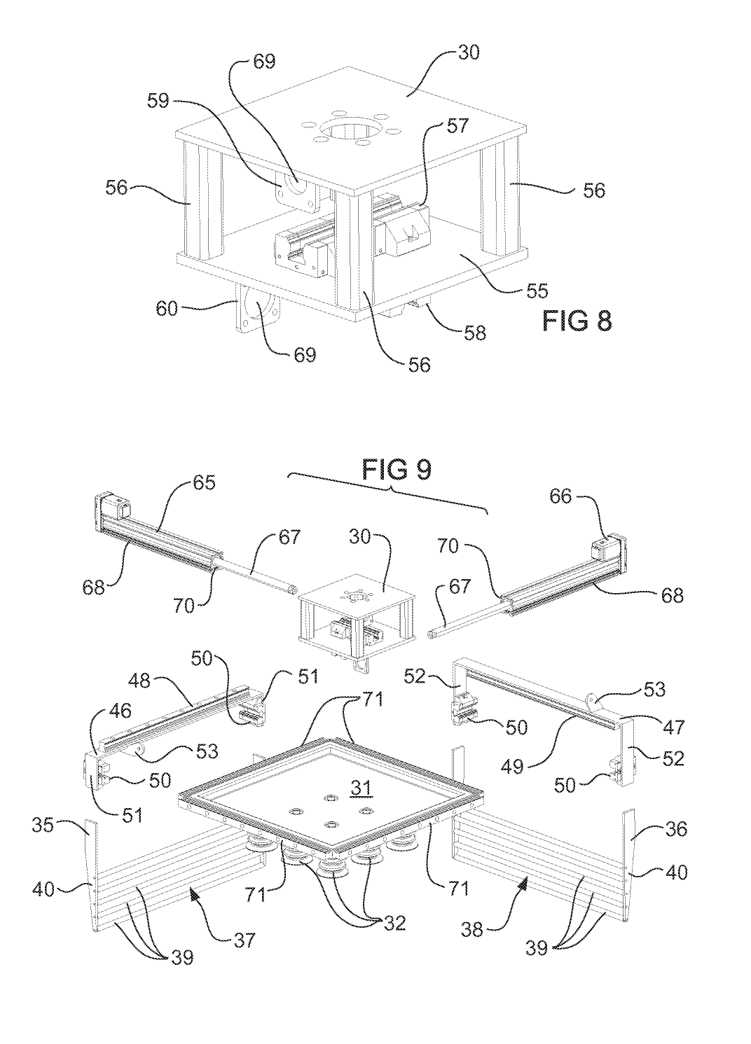

The head 26 of the palletising system 10 has a unique construction which offers significant benefits to the operation of the system 10. The robotic head 26 is illustrated individually and separate from the other components of the system 10 in FIGS. 4 to 7, while FIGS. 8 and 9 illustrate a portion of the head 26 and an exploded view of the head respectively.

The head 26 includes a connection plate 30 by which a connection is made with the robotic arm 25, and a working plate 31. The working plate 31 supports a plurality of suction cups 32 on an underside of the plate 31 and facilitates delivery of vacuum to the cups 32 so that the cups 32 can apply a suction load to upper surfaces of cartons which are engaged by the head 26 to shift from the loading region 27 to the palletising region 28 of the palletising system 10. The vacuum is used to hold the cartons securely against the abutments 35 and 36 during deceleration of the head 26 as the head approaches the position in which the cartons are to be placed. Other alternative stabilising devices could be employed for this purpose, including friction material (not illustrated) that is applied to the underside of the plate 31 and that bears against facing surfaces of cartons which are engaged by the head 26 to shift from the loading region 27 to the palletising region 28. Friction material can provide the same effect as the suction cups described above in terms of holding the cartons securely against the abutments 35 and 36 during deceleration of the head 26 but advantageously, the friction material can have costs advantages given that suction is not required to be delivered to the head 26.

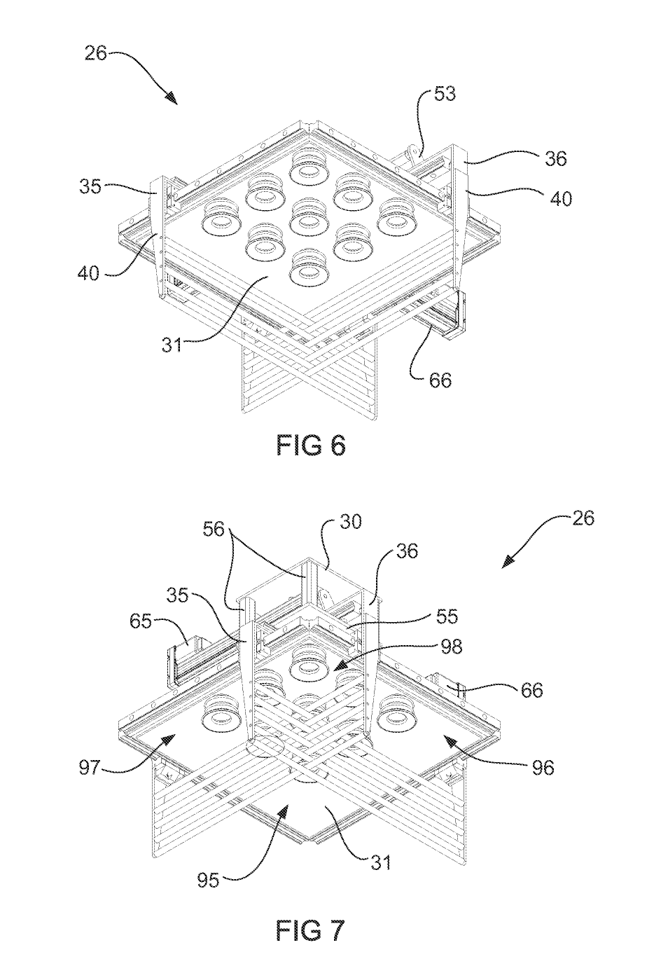

Another alternative stabilising device employable for this purpose can include retention plates (not illustrated) that extend downwardly from the plate 31 adjacent edges of the plate 31, such as the edges opposite the position of the abutments 35 and 36 in FIG. 6. The retention plates can have a short vertical extension of about 50 mm to engage top faces of a carton or group of cartons, so that the carton or group of cartons is engaged on two faces by the movable abutments 35 and 36 and on one or two opposite faces by the retention plates.

The head 26 further includes first and second moveable abutments 35 and 36. Each of the abutments 35 and 36 is moveable independently of the other so that the abutment 35 can move forward and back in the direction of the arrow A, and the abutment 36 can move forward and back in the direction of the arrow B (see FIG. 4) and movement of one abutment does not require or influence movement of the other. The amount of movement available to each abutment 35 and 36 is up to about 600 mm.

Movement of the abutments 35 and 36 is through a ball screw arrangement which is driven electrically, although it would be readily apparent to persons skilled in the art, that pneumatic or hydraulic rams could be employed, or other driving systems.

Each of the abutments 35 and 36 includes a carton engagement section 37 and 38 (see FIG. 9), which presents a generally planar engagement surface through the plurality of elongate bars 39 that extend between the side members 40. Each of the abutments 35 and 36 also includes a respective top member 46 and 47, each of which includes an elongate rail 48, 49. The respective rails 48 and 49 are disposed on opposite sides of the members 46 and 47 as illustrated in FIG. 9. The abutments 35 and 36 include inwardly facing channels 50 at each of two opposite downturned ends 51 and 52. The downturned ends 52 have a greater lengthwise extent than the ends 51 so that the top member 47 can overly the top member 46 in the assembled form of the head 26 (see FIGS. 4 and 5). Each abutment 35 and 36 includes an anchor 53.

The connection plate 30 is connected to a drive plate 55 via columns 56. Applied to each of the opposite sides of the drive plate 55 are channels 57 and 58 (FIG. 8). The grooves of the channels 57 and 58 run perpendicular to each other. Anchor plates 59 and 60 extend downwardly from each of the connection plate 30 and the drive plate 55 and the anchor plates are disposed perpendicular to each other.

The head 26 also includes a ball screw drive in the form of ball screws 65 and 66. The ball screws 65 and 66 each include a screw 67 and a housing 68. The screw 67 of each ball screw 65 and 66 extends through the opening 69 in the respective anchor plates 59, 60 and connects to a respective anchor 53. The forward end 70 of each housing 68 is connected to the anchor plates 59, 60.

In the assembled form of the head 26, the ball screws 65 and 66 are fixed to the anchors 53 and the anchor plates 59 and 60. In addition, the rails 48 and 49 of the top members 46 and 47 are located within the grooves of the channels 58 and 57 respectively and pairs of opposite side edges 71 of the working plate 31 are captured within the grooves of the respective channels 50 of each of the top members 46 and 47. Thus, considering the ball screw 65, movement of the screw 67 from the extended position of FIG. 4 to the retracted position of FIG. 5, results in forward movement of the drive plate 55 and the associated components connected to the drive plate, relative to both the abutment member 36 and the working plate 31. Because the rail 48 of the abutment 35 is captured in the groove of the channel 58, the abutment 35 is caused to move with the drive plate 55 in the direction A, from the rearward position of FIG. 4 to the forward position of FIG. 5. Only forward and backward movement of the abutment 35 in the direction A is possible because of the cooperation of the channels 50 with the side edges 71.

Likewise, considering the ball screw 66, the rail 49 of the top member 47 is captured in the groove of the channel 57, and movement of the screw 67 from the extended position of FIG. 4 to the retracted position of FIG. 5, results in forward movement of the abutment 36 in the direction B, for the same reasons as described above in relation to the ball screw 65. Neither of the abutments 35 and 36 interferes with the other because the greater lengthwise extent of the ends 52 of the top member 47 means that the top member 47 overlies the top member 46. It can be seen that the top member 47 extends over the upper surface of the drive plate 55 while the top member 46 extend underneath the drive plate 55. The spacing of the bars 39 of each of the abutments 35 and 36 allows them to intermesh (see FIGS. 4 to 7).

FIGS. 4 to 7 show movement of the abutments 35 and 36 when both of the ball screws 65 and 66 are activated to the same extent. Thus, the movement of the drive plate 55 in those figures is diagonal movement across the working plate 31 and each of the abutments 35 and 36 is moved to the same extent. In this movement, the rails 48 and 49 slide within the grooves of the channels 57 and 58.

It will be apparent from FIGS. 4 to 7 and 9, that the abutments 35 and 36 are oriented generally perpendicular to each other and each of the abutments 35 and 36 is movable relative to the other abutment between the positions shown in FIGS. 4 and 5 and FIGS. 6 and 7. Movement of one abutment does not influence movement of the other abutment. Moreover, as explained earlier, the head 26 is rotatable. Accordingly, the head 26 can be manipulated to engage and orient cartons for palletising in a highly efficient manner and with advantages over prior art palletising systems.

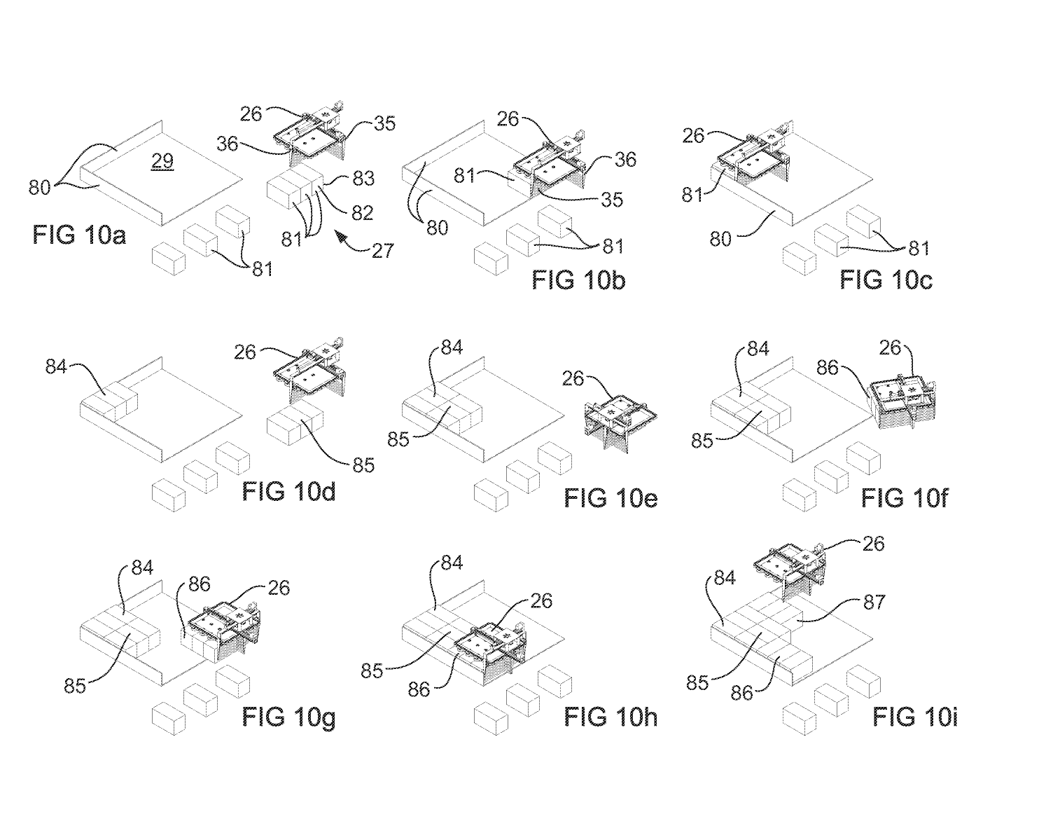

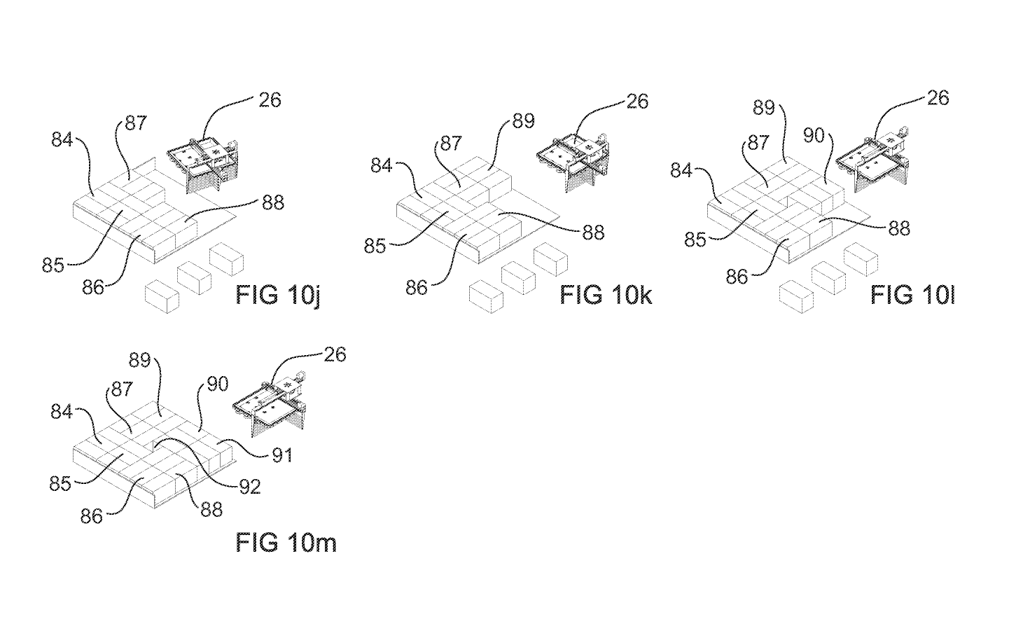

FIGS. 10a to 10m illustrate a sequence of stages of a palletising process in which the head 26 of the palletising system 10 is used to shift cartons onto the stripper 29. For the purposes of explanation, only the stripper 29 of the palletising system 10 is shown, along with a pair of abutments 80 (see FIG. 1 also) which are disposed at right angles to each other and which form a datum point for the initial cartons which are loaded onto the stripper. The position of the abutments 80 is adjustable depending on where the datum point is to be located, but they are fixed during each palletising operation.

In FIG. 10A, a plurality of cartons 81 is conveyed towards the loading region 27 of the palletising system 10 at which region, the cartons are positioned for engagement by the head 26. As will become clear later in the discussion of FIGS. 10A to 10M, the conveyer system is programmed to convey a selected number of cartons 81 to the loading region 27.

In FIG. 10a, a lead group of 3 cartons 81 is positioned in the loading region 27. The head 26 is positioned above the cartons 81 by the robotic arm 25. In FIG. 10b, the head 26 has been lowered by the robotic arm 25 into a position in which the abutments 35 and 36 engage the cartons 81 along two sides or faces 82 and 83 (FIG. 10a) of what will now be referred to as the carton group 84. In FIG. 10b, the engagement between the carton group 84 and the abutments 35 and 36 has been made and the head 26 has been shifted by the robotic arm 25 so that the carton group 84 has been pushed to the top corner of the stripper 29, remote from the abutments 80.

FIG. 10c shows further movement of the head 26 to move the carton group 84 to position it into engagement with the abutments 80, along two sides or faces of the group 84 as shown in FIG. 10d.

FIG. 10d shows a second carton group 85, also formed of three cartons 81, having been conveyed to the loading region 27 and the head 26 having been returned to the loading region 27. The carton group 84 has been positioned as required and is left in that position as new carton groups are introduced onto the stripper 29. The head 26 is lowered into engagement with the carton group 85 to engage the carton group 85 by the abutments 35 and 36. The head 26 does this in the manner shown in FIG. 10b and shifts the carton group 85 in the manner shown in FIG. 10c, but to position the carton group 85 adjacent to the carton group 84 as shown in FIG. 10e.

FIG. 10e shows the head 26 positioned again above the loading region 27, but rotated 90° from the position it took in the earlier figures. Thus, the abutments 35 and 36 have been rotated 90° from their position in the earlier figures.

With the head 26 and the abutments 35 and 36 in the orientation shown in FIG. 10e, the head 26 can be lowered into engagement with a further set of 3 cartons 81 forming a carton group 86 (FIG. 10f). It is to be noted that despite rotation of the head 26, the abutments 35 and 36 engage the carton group 86 from the same side as shown in the earlier figures. The head 26 is then rotated clockwise and moved into position on the stripper 29 as shown in FIGS. 10g and 10h. The carton group 86 is thus positioned on the stripper as shown in FIG. 10i.

A further carton group 87 is shown in FIG. 10i positioned on the stripper 29 and that carton group would be engaged and positioned in the same manner as the carton group 86, but just to a different position on the stripper 29.

Referring to FIGS. 10j to 10m, in FIG. 10j, a carton group 88 has been added adjacent to the carton group 86 in the same manner as the carton groups 86 and 87. In FIG. 10k, the carton group 89 has been added, again in the same movement of the head 26 as required for the carton groups 86 to 88. In FIG. 10l, the carton group 90 has been added and this is added in the same manner as the earlier carton groups 84 and 85. Thus, for the carton group 90, the abutments 35 and 36 are returned to the position shown in FIG. 10a, and the carton group 90 is engaged and shifted in the same manner as the carton groups 84 and 85. A final carton group 91 is shifted again in the same manner as the carton group 90 to complete the pattern of cartons on the stripper 29. It can be seen that a central gap 92 is formed between the respective groups in the pattern of cartons that has been formed.

A major advantage of the arrangement illustrated in FIGS. 10a to 10m, is that the head 26 can shift a plurality of cartons at one time. In the example given, in each carton group there is three cartons and so for each movement of the head 26, three cartons are shifted as a group onto the gripper 29. It would be clearly apparent that more or less than three cartons can be shifted at one time depending on the carton size and the pattern of cartons to be produced.

The ability to engage more than a single carton at one time means that the speed of palletising can be increased dramatically over some prior art arrangements. In the example given in FIGS. 10a to 10m, some prior art palletisers would have picked and placed each of the cartons of the various carton groups 84 to 91 individually and placed them on the stripper 29. In those prior art arrangements, 24 movements of a head would be required. However, given that the head 26 of the invention can shift more than a single carton at one time and in the example given 3 cartons at one time, only 8 movements of the head 26 is required. The speed of palletising is thus reduced by a factor of 3.

The pattern of cartons that is formed on the stripper 29 can take different forms depending on the carton size and shape. This is a unique aspect of the invention in which provides complete flexibility for changing the pattern or format of cartons which are loaded onto a pallet and provides advantages over prior art arrangements that employ infeed collation systems of the kind discussed above.

In some uses of the present invention, the head 26 can engage different numbers of cartons in each group. For example, the pattern may require a pair of cartons to be located at one position on the stripper 29, and three or four cartons to be located at a different position on the stripper 29. Thus, use of the invention is not limited to positioning carton groups with equal numbers of cartons. Moreover, it might be that a pallet of cartons might include cartons of different shapes and the invention can accommodate this by carefully selecting the position of the abutments 35 and 36, and by rotation of the head 26.

It would be readily apparent that alternatives to the specific form of the head 26 as illustrated in the figures can be adopted. For example, it has already been mentioned that the ball screws 65 and 66 are just one form of drive that could be employed. Likewise, the channels 57 and 58 could be reversed, so that the drive plate 55 includes a rail and channels were formed on the top members 46 and 47. In addition, the suction caps 32 can be provided if required or a different form of stabilizing device can be employed.

The use of horizontal bars 39 is considered advantageous in order to allow the respective abutments 35 and 36 to shift without interference between them, however alternative arrangements could be employed which continue to maintain a lack of interference between the abutments.

It is to be noted that engagement of cartons can be on either side of the abutments 35 and 36 as required to form a particular pattern on a pallet or stripper. However, in the sequence of FIGS. 10a to 10m, the engagement is always with the same side.

It will also be readily understood that movement of the abutments 35 and 36 can create four different quadrants of space (see quadrants 95 to 98 in FIG. 7), for engagement of a carton or carton groups. It will be appreciated that the quadrant 98 provides an area for engagement of a relatively small carton, while the quadrant 95 provides for engagement of a larger carton or group of cartons. Each of the quadrants 95 to 98 can be increased or decreased in area by movement of one or each of the abutments 35 and 36. Moreover, the shape of the quadrants 95 to 98 can be altered from square to rectangular again by movement of the abutments 35 and 36.

Finally, it is to be understood that various alterations, modifications and/or additions may be introduced into the constructions and arrangements of parts previously described without departing from the spirit or ambit of the invention.

1. A palletiser including
a conveyor for conveying objects to be palletised to a loading region,
a palletising head which is movable between the loading region and a palletising region,
the palletising head being rotatable and having first and second movable abutments which are oriented generally perpendicular to each other, each movable abutment being movable relative to and independently of the other movable abutment in a manner to maintain the generally perpendicular orientation between them,
the movable abutments being operable to engage surfaces of one or more objects to be palletised in the loading region, the surfaces being generally perpendicular to each other and upon that surface engagement, the palletising head being operable to shift the objects from the loading region to the palletising region and to orientate the objects through rotation of the palletising head to adopt a selected pattern of objects in the palletising region.

2. A palletiser according to claim 1, the palletising head being fixed to one end of a robotic arm and the robotic arm being operable to move the palletising head between the loading region and the palletising region.

3-4. (canceled)

5. A palletiser according to claim 1, at least one of the movable abutments having front and rear faces each of which includes a generally planar engagement surface to engage the objects to be palletised, so that the objects to be palletised can be engaged on either side of the movable abutment.

6. A palletiser according to claim 1, each of the movable abutments being movable forward and back, with movement of a first of the movable abutments being along a first line and movement of a second of the movable abutments being along a second line which is generally perpendicular to the first line.

7. A palletiser according to claim 1, the movable abutments being intermeshed but being movable relative to the other without interference.

8. A palletiser according to claim 7, the movable abutments including a plurality of vertically spaced apart, horizontal bars, with the horizontal bars of one of the movable abutments being intermeshed with the horizontal bars of the other of the movable abutments, the positions of the respective horizontal bars being such that vertically adjacent bars do not interfere with each other.

9. A palletiser according to claim 1, the movable abutments each being in engagement with a drive plate, whereby movement of the drive plate causes movement of one or both of the abutments.

10. A palletiser according to claim 9, the drive plate having opposite sides and the movable abutments being in engagement with respective opposite sides of the plate.

11. (canceled)

12. A palletiser according to claim 1, including a guide arrangement, which is engaged by the movable abutments and which restricts movement of the abutments other than in an orientation in which the abutments are generally perpendicular to each other.

13. A palletiser according to claim 12, the guide arrangement including a first pair of generally parallel and spaced apart members that are engaged by a first of the movable abutments and a second pair of generally parallel and spaced apart members that are engaged by a second of the movable abutments, the first and second pairs of members being disposed generally perpendicular to each other and being operable to maintain the abutments generally perpendicular to each other.

14.-18. (canceled)

19. A palletising head for engaging objects to be palletised, the palletising head having first and second movable abutments which are oriented generally perpendicular to each other, each movable abutment being movable relative to and independently of the other movable abutment in a manner to maintain the generally perpendicular orientation between them, the movable abutments being operable to engage surfaces of one or more objects to be palletised, the surfaces being generally perpendicular to each other and to orientate the objects through rotation of the palletising head to adopt a selected pattern of objects in a palletising region.

20. (canceled)

21. A palletising head according to claim 19, at least one of the movable abutments having front and rear faces each of which includes a generally planar engagement surface to engage objects to be palletised, so that the objects to be palletised can be engaged on either side of the movable abutment.

22. A palletising head according to claim 19, each of the movable abutments being movable forward and back, with movement of a first of the movable abutments being along a first line and movement of a second of the movable abutments being along a second line which is generally perpendicular to the first line.

23. A palletising head according to claim 19, the movable abutments being intermeshed but being movable relative to the other without interference.

24. A palletising head according to claim 23, the movable abutments including a plurality of vertically spaced apart, horizontal bars, with the horizontal bars of one of the movable abutments being intermeshed with the horizontal bars of the other of the movable abutments, the positions of the respective horizontal bars being such that vertically adjacent bars do not interfere with each other.

25. A palletising head according to claim 19, the movable abutments each being in engagement with a drive plate, whereby movement of the drive plate causes movement of one or both of the abutments.

26. A palletising head according to claim 25, the drive plate having opposite sides and the movable abutments being in engagement with respective opposite sides of the plate.

27. (canceled)

28. A palletising head according to claim 19, including a guide arrangement, which is engaged by the movable abutments and which restricts movement of the abutments other than in an orientation in which the abutments are generally perpendicular to each other.

29. A palletising head according to claim 28, the guide arrangement including a first pair of generally parallel and spaced apart members that are engaged by a first of the movable abutments and a second pair of generally parallel and spaced apart members that are engaged by a second of the movable abutments, the first and second pairs of members being disposed generally perpendicular to each other and being operable to maintain the abutments generally perpendicular to each other.

30.-33. (canceled)

34. A method of palletising objects, the method including conveying objects to be palletised to a loading region, engaging the objects by a palletising head, the palletising head being rotatable and having first and second movable abutments which are oriented generally perpendicular to each other, each movable abutment being movable relative to and independently of the other movable abutment in a manner to maintain the generally perpendicular orientation between them, engaging surfaces of one or more objects to be palletised by the first and second movable abutments in the loading region, the surfaces being generally perpendicular to each other and upon that surface engagement, shifting the objects by the palletising head from the loading region to a palletising region and during that shift, orientating the objects through rotation of the palletising head to adopt a selected pattern of objects in the palletising region.
